(19) United States
(12) Patent Application Publication
(10) Pub. No.: US 2004/0142819 A1
(43) Pub. Date: Jul. 22, 2004

(54) Compositions and methods for synergistic weed control

(76) Inventor: Robert M. Watkins, Starkville, MS (US)

Correspondence Address: Keil & Weinkauf, 1350 Connecticut Avenue NW, Washington, DC, 20036, US

(21) Appl. No.: 10/478,599

(22) PCT Filed: May 23, 2002
(86) PCT No.: PCT/EP02/05656

(51) Int. Cl. A01N 43/56

(52) U.S. Cl. 504/139

(57) ABSTRACT

The present invention describes synergistic herbicidal compositions, including their methods of use. The herbicidal compositions include an imidazolinone herbicide or an agronomically acceptable salt thereof, and a graminicide or an agronomically acceptable salt thereof; wherein the respective herbicidal constituents are present in amounts to exhibit synergistic effects. Such compositions are useful in methods of herbicidally treating weeds wherein the method includes contacting the undesired plant or area intended for crop plants with a synergistically effective amount of such an herbicidal combination or composition of an imidazolinone herbicide and graminicide.

### FIELD OF THE INVENTION

The present invention relates to new herbicidal compositions and their methods of use, in particular, the present invention relates to compositions of imidazoline herbicide(s) with graminicide(s) for synergistic control of weeds.

### BACKGROUND OF THE INVENTION

Many herbicidal compounds are selective in controlling only certain types of weeds. Applying combinations of selective herbicidal compounds simultaneously, as in a tank mixture, to control a broad spectrum of weeds is desirable due to application time and cost savings. However, in practice, herbicidal compounds generally are applied sequentially because tank mixing different herbicides can result in negative herbicidal interactions (antagonism). Antagonism occurs when a composition containing a combination of two or more herbicidal compounds exhibits a lower herbicidal effectiveness than is predicted. See Shaw and Wixson, “Postemergence Combinations of Imazaquin or Imazethapyr with AC 263,222 for Weed Control in Soybean,” 39 Weed Science 644-49 (1991).

Several selective herbicidal compounds are known in the art. Such herbicidal compounds may be applied to weeds either pre-emergence (“PRE”) or post-emergence (“POST”). Researchers have discovered that antagonism is common for tank-mixed POST herbicides, such as broadleaf herbicides mixed with grass-controlling herbicides (“graminicides”). To minimize this antagonism, researchers have recommended applying these herbicides sequentially with at least 1 day between herbicidal applications. Myers and Coble, “Antagonism of Graminicide Activity on Annual Grass Species by Imazethapyr,” 6 Weed Technology 333-38 (1992). Researchers also recommend minimizing antagonism by applying the combination of herbicides with an excess of the herbicidally effective amount of one or more of the herbicides (Holshouser and Coble, “Compatibility of Sethoxydim with Five Postemergence Broadleaf Herbicides,” 4 Weed Technology 128-33 (1990)), or applying the combination of herbicides with an antagonism inhibitor (U.S. Pat. No. 5,428,000 to Innami et al.). These recommendations can be inefficient and potentially damaging to the environment and to crop plants. Therefore, there is a need for improved herbicidal compositions that exhibit a synergistic effect in the control of weeds.

### SUMMARY OF THE INVENTION

As embodied and broadly described herein, this invention, in one aspect, relates to an herbicidal composition that includes an imidazolinone herbicide or an agronomically acceptable salt thereof, and a graminicide or an agronomically acceptable salt thereof; wherein the respective herbicidal constituents are present in amounts to exhibit synergistic effects.

Moreover, the present invention relates to, in one embodiment a method of herbicidally treating an undesired plant by contacting the undesired plant or area intended for crop plants with an herbicidally effective amount of an herbicidal composition that includes an imidazolinone herbicide and a graminicide, or agronomically acceptable salts or esters thereof, wherein the respective herbicidal constituents are present in amounts to exhibit synergistic effects.

The present invention also relates to a method of herbicidally treating an undesired plant by contacting the undesired plant or area intended for crop plants with an herbicidally effective amount of an herbicidal composition that includes an imidazolinone herbicide and a graminicide, or agronomically acceptable salts or esters thereof, wherein the respective herbicidal constituents are present in amounts to exhibit synergistic effects.

Advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### DETAILED DESCRIPTION

The present invention may be understood more readily by reference to the following detailed description of exemplary embodiments of the invention and the examples included therein.

Before the present compounds, compositions, and methods are disclosed and described, it is to be understood that this invention is not limited to specific synthetic methods of making that may of course vary. It is also to be understood that the terminology used herein is for the purpose of describing particular embodiments only and is not intended to be limiting.

In this specification and in the claims that follow, reference will be made to a number of terms that shall be defined to have the following meanings:

“Salt” as used herein includes salts that can form with, for example, amines, alkali metal bases and alkaline earth metal bases or quaternary ammonium bases, including zwitterions. Suitable alkali metal and alkaline earth metal hydroxides as salt formers include the hydroxides of lithium, sodium, potassium, magnesium or calcium. Illustrative examples of amines suitable for forming ammonium cations are ammonia as well as primary, secondary and tertiary amines such as methylamine, ethylamine, n-propylamine, isopropylamine, the four isomeric butylamines, n-amylamine, isoamylamine, hexylamine, heptylamine, octylamine, nonylamine, decylamine, pentadecylamine, hexadecylamine, heptade-cylamine, octadecylamine, methyl ethylamine, methyl isopropyl-amine, methyl hexylamine, methyl nonylamine, methyl pentadecyl-amine, methyl octadecylamine, ethyl butylamine, ethyl heptyl-amine, ethyl octylamine, hexyl heptylamine, hexyl octylamine, dimethylamine, diethylamine, di-n-propylamine, diisopropylamine, di-n-butylamine, di-n-amylamine, diisoamylamine, dihexylamine, diheptylamine, dioctylamine, ethanolamine, n-propanolamine, iso-propanolamine, N,N-diethanolamine, N-ethylpropanolamine, N-butyl-ethanolamine, allylamine, n-but-2-enylamine, n-pent-2-enylamine, 2,3-dimethylbut-2-enylamine, dibut-2-enylamine, n-hex-2-enyl-amine, propylenediamine, trimethylamine, triethylamine, tri-n-propylamine, triisopropylamine, tri-n-butylamine, triisobutyl-amine, tri-sec-butylamine, tri-n-amylamine, methoxyethylamine and ethoxyethylamine; heterocyclic amines such as pyridine, quinoline, isoquinoline, morpholine, piperidine, pyrrolidine, indoline, quinuclidine and azepine; primary arylamines such as anilines, methoxyanilines, ethoxyanilines, o-, m- and p-toluidines, phenylenediamines, benzidines, naphthylamines and o-,m- and p-chloroanilines.

In general, “herbicidally effective amount” means the amount of herbicide needed to achieve an observable herbicidal effect on plant growth, including the effects of plant necrosis, plant death, growth inhibition, reproduction inhibition, inhibition of proliferation, and removal, destruction, or otherwise diminishing the occurrence and activity of a plant. Typically, the herbicide is useful in controlling monocotyledonous and dicotyledonous weeds. One of ordinary skill in the art will recognize that the potency and, therefore, an “herbicidally effective amount,” can vary for the various herbicidal compounds/compositions used in the invention. “Non-herbicidally effective amount” shall mean that amount of herbicide that is not an herbicidally effective amount.

“Area intended for crop plants” shall mean the area of soil and/or water in which crop plants are already growing, the area in which the seed of those crop plants already has been sown, and the area intended for growing crop plants before the seed is sown.

As used throughout, the term “contacting” is used to mean that the undesired plant and/or the area intended for crop plants (i.e. soil, water) has contact with the present compound(s) or composition(s) by application methods known in the art. As such, “contacting” includes both direct contact (applying the composition directly on the plant) and indirect contact (applying the composition to the area intended for crop plants whereupon the plant incorporates the active ingredients). This contact can take place before the undesired plant emerges from the soil (“pre-emergence” or “PRE”) or after the undesired plant emerges from the soil (“post-emergence” or “POST”). Additionally, all compounds of the present invention need not contact the undesired plant simultaneously as the present invention is intended to include application of the desired components sequentially, as long as a synergistic effect is achieved.

The term “crop plant” as used herein includes terrestrial and aquatic crop plants. Exemplary crop plants include cereal crops (wheat, rye, barley, oats), plantation crops, (rubber, pineapple, coffee, bananas, tea), orchard crop plants (citrus fruit trees, apple trees, peach trees, pear trees, nut trees, gum trees, coconut trees, olive trees), and other crop plants including, but not limited to, rice, corn, sorghum, radish, chinese cabbage, cotton, sugar cane and soybeans.

By “undesired plant” is meant to include seeds, tubers, rhizomes, and foliage broad-leaf and gramineous plants, including monocotyledon weeds of the genera: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Ischaemum, Sphenoclea, Dactyloctenium, Agrostis, Alopecurus and Apera; monocotyledon cultures of the genera: Oryza, Zea, Triticum, Hordeum, Avena, Secale, Sorghum, Panicum, Saccharum, Ananas, Asparagus and Allium; dicotyledon weeds of the genera: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver Centaurea, Trifolium, Ranunculus and Taraxacum; and dicotyledon cultures of the genera: Gossypium, Glycine, Beta, Daucus, Phaseolus, Pisum, Solanum, Linum, Ipomoea, Vicia, Nicotiana, Lycopersicon, Arachis, Brassica, Lactuca, Cucumis and Cucurbita. However, the use of the active compounds/compositions according to the invention is in no way restricted to these genera, but also extends in the same manner to other plants.

The herbicidal compositions of the present invention include at least one imidazolinone herbicide or an agronomically acceptable salt thereof and at least one graminicide or an agronomically acceptable salt thereof. As such, more than one of each of these herbicidal constituents may be present in suitable ratios.

Imidazolinone herbicides and their methods of making are disclosed in U.S. Pat. No. 4,798,619; U.S. Pat. No. 5,030,271; and “The Imidazolinone Herbicides,” CRC Press, Inc. (1991), all of which are incorporated by reference in their entireties for all purposes. Any suitable imidazolinone herbicide may be used including, but not limited to, imazamethabenz ((±)-2-[4,5-di-hydro-4-methyl-4-(1-methylethyl)-5-oxo-1H-imidazol-2-yl]-4 (and 5)-methylbenzoic acid (3:2)); imazapyr ((″)-2-[4,5-dihydro-4-methyl-4-(1-methylethyl)-5-oxo-1H-imidazol-2-yl]-3-pyridinecar-boxylic acid; imazaquin (2-(4,5-dihydro-4-methyl-4-(1-methyl-ethyl)-5-oxo-1H-imidazol-2-yl]-3-quinolinecarboxylic acid); imazethapyr (2-[4,5-dihydro-4-methyl-4-(1-methylethyl)-5-oxo-1H-imidazol-2-yl]-5-ethyl-3-pyridinecarboxylic acid); imazamox (2-[4,5-dihydro-4-methyl-4-(1-methylethyl)-5-oxo-1H-imidazol-2-yl]-5(methoxymethyl)-3-pyridinecarboxylic acid); ammonium salt; and the like, or an ester or salt thereof. Also included are optical isomers such as the R- and S-isomers.

Graminicides include any suitable herbicide effective against gramineous weeds. Exemplary graminicides include (1) diphenyl ether herbicides such as bifenox (methyl 5-(2,4-dichlorophenoxy)-2-nitrobenzoate); acifluorfen (5-[2-chloro-4-(trifluoro-methyl)phenoxy]-2-nitrobenzoic acid); fluoroglycofen carboxy-methyl 5-[2-chloro-4-(trifluoromethyl)phenoxy]-2-nitrobenzoate fomesafen (5-[2-chloro-4-(trifluoromethyl)phenoxy]-N-(methyl-sulfonyl)-2-nitrobenzamide); lactofen ((″)-2-ethoxy-1-methyl-2-oxoethyl-5-(2-chloro-4-(trifluoromethyl)phenoxy]-2-nitroben-zoate); and oxyfluorfen (2-chloro-1-(3-ethoxy-4-nitro-phenoxy)-4-(trifluoromethyl)benzene); (2) 2-(4-aryloxyphenoxy) alkanoic acid herbicides such as fenoxaprop ((″)-2-[4-[(6-chloro-2-benzoxazolyl)oxy]phenoxy]propanoic acid); fluazifop-P ((R)-2-[4-[[5-(trifluoromethyl)-2-pyridinyl]oxy]phenoxy]propanoic acid); haloxyfop (2-[4-[[3-chloro-5-(trifluoromethyl)-2-pyridinyl]oxy]phenoxy]propanoic acid); quizalofop ((″)-2-[4-((6-chloro-2-quinoalinyl)oxy]phenoxy]propanoic acid); and diclofop ((±)-2-[4-(2,4-dichlorophenoxy)phenoxy]propanoic acid); and (3) cyclohexanedione oxime herbicides such as alloxydim (methyl (E)-(RS)-3-[1-allyloxyimino)butyl]-4-hydroxy-6,6-dimethyl-2-oxocyclohex-3-enecarboxylate); clefoxydim [1,3-Cyclohexanedione, 2-[1-[[2-(4-chlorophenoxy)propoxy]amino]butyl]-5-(tetrahydro-2H-thiopyran-3-yl)-(9CI)]; clethodim ((E,E)-(″)-2-[1-([[3-chloro-2-prpenyl)oxy]imino]propyl]-5-[2-(ethylthio)propyl]-3-hydroxy-2-cyclohexen-1-one); cloproxydim ((RS)-2-[1-(3-chloroallyloxy)iminobutyl]-5-(2-ethylthiopropyl)-3-hydroxycyclohex-2-en-1-one); cycloxydim ((RS)-2-[1-(ethoxyimino)butyl]-3-hydroxy-5-thian-3-ylcyclohex-2-en-1-one); sethoxydim (2-[1-(ethoxyimino)butyl]-5-[2-(ethylthio)propyl]-3-hydroxy-2-cyclohexen-1-one); tepraloxydim ((EZ)-(RS)-2-{1-[2E)-3-chloroallyloxyimino]propyl}-3-hydroxy-5-perhydropyran-4-ylcyclohex-2-en-1-one); tralkoxydim (2-[1-(ethoxyimino)propyl]-3-hydroxy-5-mesitylcyclohex-2-en-1-one); and the like; and mixtures thereof.

The herbicidal constituents of the compositions of the present invention are present in such an amount as to provide a synergistic effect. In general, a synergistic effect means that the effectiveness of the combination of components is greater than that which is predicted. Various prediction methods are known in the art. Exemplary prediction methods are used to calculate expected interactions of herbicide tank mixtures, including those methods described by Colby in “Calculating Synergistic and Antagonistic Responses of Herbicide Combinations,” 15 Weeds 20-22 (1967); Riley and Shaw, “Influence of Imazapyr on the Control of Pitted Morningglory (Ipomea lacunosa) and Johnsongrass (Sorghum halepense) with Chlorimuron, Imazaquin, and Imazethapyr,” 36 Weed Science 663-66 (1988); Shaw and Wixson, “Postemergence Combinations of Imazaquin or Imazethapyr with AC 263,222 for Weed Control in Soybean (Glycine max),” 39 Weed Science 644-49 (1991); and Wesley and Shaw, “Interactions of Diphenylether Herbicides with Chlorimuron and Imazaquin,” 6 Weed Technology 325-51 (1992), all of which are incorporated by reference in their entireties for all purposes. Any amount of synergistic effect is suitable, such as synergistic effects of 3%, 5%, 10%, 15%, 20%, 25%, 30%, 35%, 40%, 45%, 50% and greater.

The compositions according to the present invention may contain the herbicide constituents in a wide range of ratios, depending on the particular conditions of application, the crop being treated, the weeds being combated and the type of herbicides being used in the compositions. Typically, the ratio of imidazolinone herbicide to graminicide in the present compositions may be in the range from about 1:100 to about 10:1, in particular from about 1:20 to about 1:1.

The compositions may contain the herbicidally active components mixture in a range from 0.1 parts to 100 parts by weight and may also contain at least one agriculturally acceptable carrier. The carrier may be any natural or synthetic organic or inorganic ingredient that facilitates dispersion of the composition and contact with the plant.

Exemplary carriers include water, aqueous solutions, N-methylpyrrolidone, alcohols (e.g. methanol, ethanol, n-propanol, isopropanol, ethylene glycol, etc.), ketones (e.g. acetone, methyl ethyl ketone, etc.), ethers (e.g. dioxane, tetrahydrofuran, ethylene glycol monomethyl ether, diethylene glycol monomethyl ether, propylene glycol monomethyl ether, etc.), aliphatic hydro-carbons (e.g. kerosene, lamp oil, fuel oil, machine oil, etc.), aromatic hydrocarbons (e.g. benzene, toluene, xylene, solvent naphta, methylnaphthalene, etc.), halogenated hydrocarbons (e.g. dichloromethane, chloroform, carbon tetrachloride, etc.), acid amides (e.g. dimethylformamide, dimethylacetamide, etc.), esters (e.g. ethyl acetate, butyl acetate, fatty acid glycerol ester, etc.), nitriles (e.g. acetonitrile, propionitrile, etc.), and combinations thereof.

The compositions of the present invention may also contain one or more surfactants to increase the biological effectiveness of the active ingredient. Suitable surface active ingredients include surfactants, emulsifying agents, and wetting agents. A wide range of surfactants is available and can be selected readily by those skilled in the art from “The Handbook of Industrial Surfactants,” 2nd Edition, Gower (1997), which is incorporated herein by reference in its entirety for all purposes. There is no restriction on the type or chemical class of surfactant that can be used. Non-ionic, anionic, cationic and amphoteric types, or combinations of more than one of these types, are all useful in particular situations.

Among nonionic surfactants, exemplary classes include polyoxyethylene alkyl, alkyne, alkynyl or alkylaryl ethers, such as polyoxyethylene primary or secondary alcohols, alkylphenols or acetylenic diols; polyoxyethylene alkyl or alkyne esters, such as ethoxylated fatty acids; sorbitan alkylesters, whether ethoxylated or not; glyceryl alkylesters; sucrose esters; and alkyl polyglycosides. Exemplary anionic surfactant classes include fatty acids, sulfates, sulfonates, and phosphate mono- and di-esters of alcohols, alkylphenols, polyoxyethylene alcohols and polyoxyethylene alkylphenols, and carboxylates of polyoxyethylene alcohols and polyoxyethylene alkylphenols. These can be used in their acid form but are more typically used as salts, for example sodium, potassium or ammonium salts.

Cationic surfactants classes include polyoxyethylene tertiary alkylamines or alkenylamines, such as ethoxylated fatty amines, quaternary ammonium surfactants and polyoxyethylene alkyletheramines. Representative specific examples of such cationic surfactants include polyoxyethylene (5) cocoamine, polyoxyethylene (15) tallowamine, distearyldimethylammonium chloride, N-dodecylpyridine chloride and polyoxypropylene (8) ethoxytrimethylammonium chloride. Many cationic quaternary ammonium surfactants of diverse structures are known in the art to be useful in combination with herbicides and can be used in compositions contemplated herein.

Suitable emulsifying agents and wetting agents include, but are not limited to, ionic and nonionic types such as polyacrylic acid salts, lignosulphonic acid salts, phenolsulphonic or naphthalene-sulphonic acids, products of polycondensation of ethylene oxide with fatty alcohols, fatty acids or fatty amines, substituted phenols (especially alkylphenols or arylphenols), sulphonosuccinic acid ester salts, taurine derivatives (especially alkyl taurates), phosphoric esters of alcohols or products of polycondensation of ethylene oxide with phenols, esters of fatty acids with polyhydric alcohols, and derivatives having sulphate, sulphonate and phosphate groups, of the compounds above.

Compositions of this invention may also contain other active ingredients, for example fertilizers such as ammonium nitrate, urea, potash, and superphosphate; phytotoxicants and plant growth regulators; safeners; and pesticides. These additional ingredients may be used sequentially or in combination with the above-described compositions. For example, the plant(s) may be sprayed with a composition of this invention either before or after being treated with other active ingredients. The present invention may also be admixed with the other active ingredients and applied in a single application.

Other optional components may be admixed with the present compositions to facilitate the application and/or effectiveness of the active ingredient. To this end, optional components that may be added include antifoaming agents including silicone based antifoaming agents; thickening agents such as fumed silica; anti-microbial agents; antioxidants; buffers; dyes; perfumes; stabilizing agents; and antifreezing agents. Exemplary antifreezing agents include but are not limited to, glycols such as propylene glycol and ethylene glycol, N-methylpyrrolidone, cyclohexanone, and alcohols such as ethanol and methanol.

The compositions of the present invention are suitable for all methods of application used in agriculture, including pre-emergence application, post-emergence application, and seed dressing. Thus it is to be understood that the present invention includes the application of the individual herbicidal constituents of the compositions of the present invention simultaneously in the same application or sequentially, as in separate applications, to the undesired plant or area intended for crop plants. Such sequential applications may be performed by applying the combination of herbicides individually within a one day period or less, such as separate applications of the individual herbicides within less than 1 hour, less than 5 hours, less than 10 hours, less than 14 hours, or less than 17 hours.

As such, the compositions may be present in any effective formulation, including, but not limited to, liquid diluted and concentrated solutions (such as in the form of a tank mix), powders, emulsifications, and granules.

Typical liquid solutions include the active ingredients mixture, a carrier, and optionally, a surface active agent. The dilute solutions of the present compositions generally contain about 0.1 to about 50 parts active ingredients mixture, about 0.25 to about 50 parts carrier, and about 0 to about 94 parts surface active agent, all parts being by weight based on the total weight of the composition. Similarly, the concentrated compositions typically include about 40 to about 95 parts active ingredients mixture, about 5 to about 25 parts carrier, and about 0 to about 20 parts surface active agent.

Powders include water-dispersible compositions containing the active ingredients mixture, an inert solid extender and one or more wetting and dispersing agents. The powder compositions of this invention usually contain from about 0.5 to about 60 parts of active ingredients mixture, from about 0.25 to about 25 parts of wetting agent, from about 0.25 to about 25 parts of dispersant, and from about 5 to about 95 parts of inert solid extender, all parts being by weight of the total composition. In an exemplary embodiment, this invention contains from about 5 to about 20 parts of active ingredients mixture, from about 1 to about 15 parts of wetting agent, from about 1 to about 15 parts of dispersant, and from about 5 to about 50 parts of inert solid extender.

Emulsifications are usually solutions of herbicides in water-immiscible or partially water-immiscible solvents as the carrier together with at least one surface active agent. Suitable solvents for the active ingredients of this invention include, but are not limited to, hydrocarbons and water-immiscible ethers, esters or ketones. The emulsification compositions generally contain from about 5 to about 95 parts active ingredients mixture, from about 1 to about 50 parts surface active agent, and from about 4 to about 94 parts carrier, all parts being by weight based on the total weight of the composition. Emulsifications are especially useful in seed dressings and in applications in furrows. The emulsification may be applied to open furrows in which seeds have been sown. After covering the furrow, an herbicide may be applied separately.

An herbicidally effective amount of the composition will vary according to the prevailing conditions such as weather, plant species, feed pressure, growth stage, mode of application, cultivation practice and the like. Additionally, the amounts of the individual herbicidally active constituents in the compositions of the present invention can be reduced over the quantities required when they are used alone, such that the quantity of herbicide if used alone is non-herbicidally effective. However, the compositions of the present invention maintain their herbicidal efficacy even when the individual constituent(s) are included at such reduced levels. Herbicidally effective amounts of a composition include application of one or more imidazolinone herbicides at a rate of 0.001 lb/A (0.001 kg/ha) to about 0.2 lb/A (0.2 kg/ha) and application of one or more graminicides at a rate of about 0.01 lb/A (0.01 kg/ha) to about 1.0 lb/A (0.9 kg/ha). In one embodiment, an herbicidally effective amount includes application of one or more imidazolinone herbicides at a rate of 0.004 lb/A (0.004 kg/ha) to about 0.1 lb/A (0.1 kg/ha) and application of one or more graminicides at a rate of about 0.1 lb/A (0.1 kg/ha) to about 0.063 lb/A (0.070 kg/ha).

The compounds useful in compositions of the present invention may be readily synthesized using techniques generally known to synthetic organic chemists. In general, the compounds may also be purchased commercially. The compositions may be prepared in known manner, for example by homogeneously mixing or grinding the active ingredients with other ingredients. Additional components may be admixed with the composition at any point during the process, including during and/or after any mixing step of the herbicide components.

When operating in accordance with the present invention, the undesired plant or area intended for crop plants is contacted with an herbicidally effective amount of the composition of the present invention to obtain a synergistic effect. The application of such herbicidal compositions to terrestrial plants can be carried out by conventional methods, e.g. power dusters, boom and hand sprayers and spray dusters. The compositions can also be applied from airplanes as a dust or a spray because of their effectiveness at low dosages. The application of herbicidal compositions to aquatic plants is usually carried out by spraying the compositions on the aquatic plants in the area where control of the aquatic plants is desired.

Experimental:

The following examples are put forth so as to provide those of ordinary skill in the art with a complete disclosure and description of how the compounds, compositions, combinations and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.) but some errors and deviations should be accounted for. Unless indicated otherwise, percent is percent by weight given the component and the total weight of the composition, temperature is in ° C. or is at ambient temperature, and pressure is at or near atmospheric.

### EXAMPLE 1

Evaluation of the Enhanced Herbicidal Effect of the Combination of Sethoxydim with Imazaquin or Imazamox as Measured by Weed Control

In this evaluation, seedling johnsongrass was grown in 9-cm diameter styrofoam cups in a soil medium of a 1:1 mixture of top-soil from a Freestone fine sandy loam (fine-loamy, siliceous, thermic Aquic Paleudalf) and masonry sand. The temperature in the greenhouse was maintained at 31 ″5° C. for several weeks until the plants were approximately 5-inch (13 cm) leaf seedlings. Said plants were then sprayed with an aqueous solution of the test compounds at the rates indicated in Tables Ia and Ib as measured in lbs of herbicide per acre. Each treatment was replicated 4 times and the average control % (on a visual basis) is shown in Table Ia for 10 days after treatment and Table Ib for 20 days after treatment.

The methods described by Colby in “Calculating Synergistic and Antagonistic Responses of Herbicide Combinations,” 15 Weeds 20-22 (1967), were used to calculate interactions of herbicide tank mixtures. The expected response for tank mixtures was calculated by taking the product of the recorded values from the herbicides applied alone and dividing by 100. This value, subtracted from the sum of the recorded values for the herbicide applied alone, yielded the expected response (Expected Control). Synergistic or antagonistic interactions were determined when the actual observed response to the herbicide combination was significantly different than the expected response according to Fisher's protected Least Significant Difference (LSD) Test using significance level 0.05. See Riley and Shaw, “Influence of Imazapyr on the Control of Pitted Morningglory (Ipomea lacunosa) and Johnsongrass (Sorghum halepense) with Chlorimuron, Imazaquin, and Imazethapyr,” 36 Weed Science 663-66 (1988); Shaw and Wixson, “Post-emergence Combinations of Imazaquin or Imazethapyr with AC 263,222 for Weed Control in Soybean (Glycine max),” 39 Weed Science 644-49 (1991); Wesley and Shaw, “Interactions of Diphenylether Herbicides with Chlorimuron and Imazaquin,” 6 Weed Technology 325-51 (1992). When the expected and the observed values were not significantly different, the herbicide combination was declared additive.

TABLE Ia
Percent Control of Sorghum halepense (Johnsongrass)
10 Days After Treatment

| Sethoxyd | | Imidazolinone | Actual | Expected | Difference |
|---|---|---|---|---|---|
| im: Rate in lb/A | Imidazolinone | Rate in lb/A | Control | Control | and |
| (in kg/ha) | Herbicide | (in kg/ha) | (%) | (%) | Significance |
| 0 | None | 0 (0) | 0 | | |
| (0) | | | | | |
| 0 | imazamox | 0.004 | 12.5 | | |
| (0) | | (0.004) | | | |
| 0 | imazamox | 0.008 | 12.5 | | |
| (0) | | (0.009) | | | |
| 0 | imazamox | 0.016 | 10 | | |
| (0) | | (0.018) | | | |
| 0 | imazamox | 0.032 | 10 | | |
| (0) | | (0.036) | | | |
| 0 | imazaquin | 0.008 | 0 | | |
| (0) | | (0.009) | | | |
| 0 | imazaquin | 0.016 | 0 | | |
| (0) | | (0.018) | | | |
| 0 | imazaquin | 0.032 | 0 | | |
| (0) | | (0.036) | | | |
| 0 | imazaquin | 0.063 | 0 | | |
| (0) | | (0.070) | | | |
| 0.1 | None | 0 (0) | 20 | | |
| (0.1) | | | | | |
| 0.1 | imazamox | 0.004 | 15 | 30 | −15 |
| (0.1) | | (0.004) | | | |
| 0.1 | imazamox | 0.008 | 52.5 | 30 | +22.5* |
| (0.1) | | (0.009) | | | |
| 0.1 | imazamox | 0.016 | 65 | 28 | +37* |
| (0.1) | | (0.018) | | | |
| 0.1 | imazamox | 0.032 | 67.5 | 28 | +39.5* |
| (0.1) | | (0.036) | | | |
| 0.1 | imazaquin | 0.008 | 75 | 20 | +55* |
| (0.1) | | (0.009) | | | |
| 0.1 | imazaquin | 0.016 | 65 | 20 | +45* |
| (0.1) | | (0.018) | | | |
| 0.1 | imazaquin | 0.032 | 75 | 20 | +55* |
| (0.1) | | (0.036) | | | |
| 0.1 | imazaquin | 0.063 | 50 | 20 | +30* |
| (0.1) | | (0.070) | | | |
| 0.2 | None | 0 (0) | 87.5 | — | — |
| (0.2) | | | | | |
| 0.2 | imazamox | 0.032 | 83.75 | 88.75 | −5 |
| (0.2) | | (0.036) | | | |
| 0.2 | imazaquin | 0.063 | 91.25 | 87.5 | +3.75 |
| (0.2) | | (0.070) | | | |
| | | | | | LSD = 8.3 |

*Difference represents a synergistic effect because the Difference (Actual Control − Expected Control) is significantly higher than the LSD.

TABLE Ib
Percent Control of Sorghum halepense (Johnsongrass)
20 Days After Treatment

| Sethoxyd | | Imidazolinone | Actual | Expected | Difference |
|---|---|---|---|---|---|
| im: Rate in lb/A | Imidazolinone | Rate in lb/A | Control | Control | and |
| (in kg/ha) | Herbicide | (in kg/ha) | (%) | (%) | Significance |
| 0 | None | 0 | 0 | | |
| (0) | | (0) | | | |
| 0 | imazamox | 0.004 | 30 | | |
| (0) | | (0.004) | | | |
| 0 | imazamox | 0.008 | 40 | | |
| (0) | | (0.009) | | | |
| 0 | imazamox | 0.016 | 40 | | |
| (0) | | (0.018) | | | |
| 0 | imazamox | 0.032 | 50 | | |
| (0) | | (0.036) | | | |
| 0 | imazaquin | 0.008 | 0 | | |
| (0) | | (0.009) | | | |
| 0 | imazaquin | 0.016 | 2.5 | | |
| (0) | | (0.018) | | | |
| 0 | imazaquin | 0.032 | 3.8 | | |
| (0) | | (0.036) | | | |
| 0 | imazaquin | 0.063 | 5 | | |
| (0) | | (0.070) | | | |
| 0.1 | None | 0 (0) | 30 | | |
| (0.1) | | | | | |
| 0.1 | imazamox | 0.004 | 65 | 51 | +14* |
| (0.1) | | (0.004) | | | |
| 0.1 | imazamox | 0.008 | 85 | 58 | +27* |
| (0.1) | | (0.009) | | | |
| 0.1 | imazamox | 0.016 | 77.5 | 58 | +19.5* |
| (0.1) | | (0.018) | | | |
| 0.1 | imazamox | 0.032 | 75 | 65 | +10* |
| (0.1) | | (0.036) | | | |
| 0.1 | imazaquin | 0.008 | 63.8 | 30 | +33.8* |
| (0.1) | | (0.009) | | | |
| 0.1 | imazaquin | 0.016 | 75 | 31.75 | +43.25* |
| (0.1) | | (0.018) | | | |
| 0.1 | imazaquin | 0.032 | 77.5 | 32.63 | +44.88* |
| (0.1) | | (0.036) | | | |
| 0.1 | imazaquin | 0.063 | 67.5 | 33.5 | +34* |
| (0.1) | | (0.070) | | | |
| 0.2 | None | 0 (0) | 95 | — | — |
| (0.2) | | | | | |
| 0.2 | imazamox | 0.032 | 94 | 97.5 | −3.5 |
| (0.2) | | (0.036) | | | |
| 0.2 | imazaquin | 0.063 | 95 | 95.25 | −0.25 |
| (0.2) | | (0.070) | | | |
| | | | | | LSD = 5.1 |

*Difference represents a synergistic effect because the Difference (Actual Control − Expected Control) is significantly higher than the LSD.

### EXAMPLE 2

Evaluation of the Enhanced Herbicidal Effect of the Combination of Sethoxydim with Imazapyr as Measured by Weed Control

In this evaluation, seedling weeds of rhizome johnsongrass and white clover were grown in a field plot until they reached a height of 3 feet (0.9 m) and 3 inches (8 cm) respectively. The plants were then sprayed with an aqueous solution or emulsification of the test compounds at various rates as indicated in Table II. The control % (on a visual basis) is shown in Table II for 7 and 16 days after treatment.

TABLE II
Percent Control of Weeds 7 and 16 Days After Treatment
(DAT)

| | | | | | | | TRFRE |
|---|---|---|---|---|---|---|---|
| | | Gramidicide | Imidazolinone | SORHAZ | TRFRE | SORHAZ | 16 |
| | Gramidicide/ | Rate in | Rate in | 7 DAT | 7 DAT | 16 DAT | DAT |
| | Imidazolinone | lb/A (in | lb/A (in | Control | Control | Control | Control |
| Treatment | Herbicide | kg/ha) | kg/ha) | (%) | (%) | (%) | (%) |
| 1 | none/none | 0 | 0 | 0 | 0 | 0 | 0 |
| | | (0) | (0) | | | | |
| 2 | sethoxdim/ | 0.20 | 0 | 26.7 | 0 | 38.3 | 0 |
| | none | (0.22) | (0) | | | | |
| 3 | none/imazapyr | 0 | 0.008 | 0 | 0 | 0 | 0 |
| | | (0) | (0.009) | | | | |
| 4 | sethoxydim/ | 0.20 | 0.008 | 85.0 | 13.3 | 91.7 | 18.3 |
| | imazapyr | (0.22) | (0.009) | | | | |

In Table II:

Sethoxydim is formulated as a 1.5 lb ai/g (0.68 kg ai/g) emulsification.

Imazapyr is formulated as a 4.0 lb ai/g (1.8 kg ai/g) aqueous solution.

SORHAZ is johnsongrass with an approximate height of 3 feet (0.9 m).

TRFRE is white clover with an approximate height of 3 inches (8 cm).

Throughout this application, various publications are referenced. The disclosures of these publications in their entireties are hereby incorporated by reference into this application for all purposes.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An herbicidal composition comprising:
a) an imidazolinone herbicide or an agronomically acceptable salt thereof, and
b) sethoxydim or an agronomically acceptable salt thereof;
wherein the respective herbicidal constituents are present in amounts to exhibit synergistic effects.

2. The composition of claim 1, wherein the imidazolinone herbicide is imazamethabenz-methyl, imazapyr, imazaquin, imazethapyr, imazamox, imazapic, or an agronomically acceptable salt thereof.

3. The composition of claim 1, wherein the imidazolinone herbicide is imazamox or imazaquin, or an agronomically acceptable salt thereof.

4. The composition of claims 1 to 3, wherein the ratio of imidazolinone herbicide to sethoxydim is in the range of about 1:100 to about 10:1.

5. The composition of claims 1 to 4, wherein the composition is a tank mixture.

6. A method of herbicidally treating an undesired plant comprising contacting the undesired plant or area intended for crop plants with an herbicidally effective amount of a combination of herbicides comprising:
a) an imidazolinone herbicide or an agronomically acceptable salt thereof, and
b) sethoxydim or an agronomically acceptable salt thereof;
wherein the respective herbicidal constituents are present in amounts to exhibit synergistic effects.

7. The method of claim 6, wherein the herbicidal constituents are applied sequentially.

8. The method of claim 7, wherein the imidazolinone herbicide is present in a non-herbicidally effective amount.

9. The method of claim 7, wherein the ratio of imidazolinone herbicide to graminicide is in the range of from about 1:100 to about 10:1.

10. A method of herbicidally treating an undesired plant comprising contacting the undesired plant or area intended for crop plants with an herbicidally effective amount of a composition comprising:
a) an imidazolinone herbicide or an agronomically acceptable salt thereof, and
b) sethoxydim or an agronomically acceptable salt thereof;
wherein the respective herbicidal constituents are present in amounts to exhibit synergistic effects.
